(19) United States
(12) Patent Application Publication
(10) Pub. No.: US 2008/0309651 A1
(43) Pub. Date: Dec. 18, 2008

(54) DRIVE CONTROL CIRCUIT DEVICE FOR FLAT PANEL DISPLAY APPARATUS

(76) Inventors: Shigeharu ASAO, Yokohama (JP); Toshio Ueda, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/026,652

(22) Filed: Feb. 6, 2008

(30) Foreign Application Priority Data
Jun. 15, 2007 (JP) 2007-158468

(51) Int. Cl. G06F 3/038

(52) U.S. Cl. 345/208

(57) ABSTRACT

Provided is a technology related to a PDP apparatus and capable of realizing the efficiency improvement in the processing of a control circuit including the processing between a control circuit (waveform generating circuit unit) and a non-volatile memory (waveform ROM). In a control circuit of a PDP apparatus, an SFM (serial flash memory) is used as a non-volatile memory, and waveform decoding data and a waveform decoding address set are stored as a first waveform in the SFM. An LSI (waveform generating circuit LSI) stores the data from the waveform decoding data in a first SRAM in an internal SRAM unit and stores the data corresponding to one reading cycle (for example one SF) selected from the waveform decoding address set in a second SRAM in the internal SRAM unit.

### CROSS-REFERENCE TO RELATED APPLICATION

The present application claims priority from Japanese Patent Application No. JP 2007-158468 filed on Jun. 15, 2007, the content of which is hereby incorporated by reference into this application.

### TECHNICAL FIELD OF THE INVENTION

The present invention relates to a flat panel display (flat panel display apparatus) such as a display apparatus (plasma display apparatus: PDP apparatus) provided with a plasma display panel (PDP). More particularly, it relates to a drive control circuit device (IC or the like) generating a waveform for driving a flat panel display.

### BACKGROUND OF THE INVENTION

The conventional PDP apparatus is provided with a PDP drive control circuit (abbreviated to control circuit) using an external non-volatile memory. In the conventional control circuit, a parallel flash memory (abbreviated to PFM) having a parallel I/F (interface) has been adopted as an external non-volatile memory in which waveform data and others (first waveform) necessary for the drive control are stored (also referred to as waveform ROM). In the control circuit, the drive waveform and the waveform data (first waveform) related to the generation thereof stored in the PFM are always read by successive clocks and outputted to a high-voltage circuit (drive circuit) through a waveform generating circuit (provided in the control circuit), thereby driving the PDP. The above-described first waveform is, for example, an ON/OFF control signal of a control switch in the drive circuit. Also, no buffer SRAM (volatile memory for temporarily storing the waveform data read from PFM) is provided in the control circuit.

Incidentally, the control circuit and the drive circuit (high-voltage circuit) connected to a panel (PDP) are separately considered. The drive circuit is controlled by a drive control signal from the control circuit (signal generated based on the first waveform (second waveform)) and a drive waveform (voltage) is applied from the drive circuit to PDP electrodes, thereby driving the PDP.

Japanese Patent Application Laid-Open Publication No. 2004-252017 (Patent Document 1) has described a technology for transferring signal/data between a display control unit (control circuit) and a drive unit (drive circuit) in a PDP apparatus and others. Also, Japanese Patent Application Laid-Open Publication No. 2003-288042 (Patent Document 2) has described a technology of a control circuit and a waveform generating circuit in a PDP apparatus (technology for skipping an address of waveform data). Further, Japanese Patent Application Laid-Open Publication No. 2004-7546 (Patent Document 3) has described a technology of a control circuit and a waveform generating circuit in a PDP apparatus (technology for extending an output period of waveform data).

### SUMMARY OF THE INVENTION

The background technologies described above contain the following problems. As a basic problem, with the further refinement in the PDP drive control, the amount of the drive waveform and the waveform data (first waveform) related to the generation thereof has been increased, and further high-speed control for the reading of the waveform data (first waveform) has been required. The details thereof will be described below.

(1) The speed and the efficiency for the processing of a control circuit (waveform generating circuit LSI or the like) including the processing with an external non-volatile memory have been restricted. For example, since 55 ns (nanosecond) is required as the minimum access time of the data bus of the conventional PFM, the speeding up of the frequency of reading clock from the PFM and the frequency of waveform generating circuit clock has been restricted.

(2) Furthermore, since about 40 control terminals are necessary because of the parallel I/F (PFM) related to a data bus and an address bus of an external non-volatile memory, an IC which performs the data processing of the memory (memory control IC in a part of the control circuit) is required to have a corresponding number of terminals, which has been one of the factors of the cost increase.

(3) Also, since a large amount of waveform data (first waveform) is stored in an external non-volatile memory (PFM), it is necessary to provide the large-capacity PFM, which has been one of the factors of the cost increase.

The present invention has been made in view of the above-described problems, and an object of the present invention is to provide a technology related to a control circuit using an external non-volatile memory in a flat panel display such as a PDP apparatus and capable of realizing: (1) the efficiency improvement in the processing of a control circuit including the processing between the control circuit (waveform generating circuit) and a non-volatile memory (waveform ROM) and the resulting efficiency improvement in the panel driving; (2) the cost reduction by reducing the number of terminals of a memory control IC or the like provided in the control circuit; and (3) the cost reduction by reducing the capacity of the external non-volatile memory.

The typical ones of the inventions disclosed in this application will be briefly described as follows. For the achievement of the above-described object, the present invention discloses a panel drive control circuit (control circuit) provided in a flat panel display (flat panel display apparatus) such as a PDP apparatus. The panel drive control circuit performs the processing for generating at least a waveform (second waveform) for driving the panel by using a drive waveform and waveform data (first waveform) related to the generation thereof stored in an external non-volatile memory (waveform ROM), and it is characterized by having the following configuration.

In the control circuit of the present invention, as an I/F between an external non-volatile memory (ROM) and a control circuit (including at least the waveform generating circuit unit for performing the above-described processing), a configuration of a serial I/F is adopted. More specifically, as the memory, a serial flash memory (abbreviated to SFM) is provided instead of conventional PFM. Also, in the control circuit of the present invention, drive waveform decoding data and address data for reading data (pattern) from the drive waveform decoding data per predetermined unit are stored as those corresponding to the first waveform in the non-volatile memory (SFM) so as to support the serial I/F configuration. Additionally, a first volatile memory storing the drive waveform decoding data as first data and a second volatile memory storing a predetermined number of sets of the address data, with the address data corresponding to one reading cycle being defined as one set, are provided as internal volatile memories in this control circuit. In this control circuit (waveform generating circuit unit), while reading the stored data from the non-volatile memory (SFM) to the internal volatile memories and storing the data therein as needed, the data stored in the memory is read to generate the second waveform, and the second waveform is outputted to the drive circuit. In the above-described configuration, the SFM can be effectively adopted instead of the conventional PFM.

According to the configuration described above, (1) the speeding up of a clock frequency such as the drive waveform generating clock in the SFM and the control circuit (waveform generating circuit unit); (2) the reduction in the number of terminals of a memory control IC or the like provided in the waveform generating circuit unit by the adoption of the serial I/F (serial data bus or the like); and (3) the reduction in the capacity by the ingenuity for the format of the store data (first waveform) in the SFM can be realized.

The configuration of the drive control circuit of the present invention is as follows. In this apparatus, a drive waveform and waveform data related to the generation thereof are stored as a first waveform in a non-volatile memory for each cycle constituted of a plurality of clock cycles, and a second waveform for driving a panel is generated by using (reading) the first waveform stored in the non-volatile memory. Further, a first volatile memory (SRAM or the like) in which drive waveform decoding data (D1) obtained by extracting a pattern of a waveform group per predetermined period (for example, one clock cycle) from all waveform groups for driving is stored as first data (d1) and a second volatile memory (SRAM or the like) in which a decoding address for reading data (pattern (waveform group)) from the drive waveform decoding data (D1), corresponding to only predetermined one reading cycle (for example, one sub-field) and serving as a decoding address set (D2), is stored as second data (d2) are provided. By this means, the decoding data of the first volatile memory is read by the decoding address of the second volatile memory, thereby generating the second waveform and outputting the same. The one reading cycle may be single or plural fields or sub-fields, a reset period, an address period or a sustain period in a sub-field.

In this apparatus, for example, the data which covers all the waveform data units used for the panel drive control, with one clock cycle of the first waveform being defined as one unit, is stored as the drive waveform decoding data (D1) of the first waveform in a non-volatile memory in advance. In other words, the drive waveform decoding data (D1) is obtained by analyzing and extracting the patterns of the waveform groups (waveform combination) per a predetermined period (for example, one clock cycle) from all the waveform groups. Note that the “one clock cycle” described above indicates a cycle for performing a series of processes of reading a decoding address from a memory, generating a drive waveform (second waveform), and outputting it to a drive circuit (high-voltage circuit). Also, in this apparatus, sets (types) of decoding addresses used for the panel drive control, with the decoding address corresponding to one reading cycle being defined as one set (decoding address set (D2)), are stored as the decoding address in the non-volatile memory in advance.

In this apparatus, for example, immediately after starting up the system, drive waveform decoding data stored in a non-volatile memory is all stored as the first data in the first volatile memory, and thereafter, the refreshing operation is performed to the first data in the first volatile memory as needed. Further, in this apparatus, the decoding address corresponding to one reading cycle which is stored in the non-volatile memory is to be stored in the second volatile memory immediately after starting up the system and after storing the decoding data.

The effects obtained by typical aspects of the present invention will be briefly described below. According to the present invention, in relation to a control circuit using an external non-volatile memory in a flat panel display such as a PDP apparatus, (1) the efficiency improvement in the processing of a control circuit including the processing between the control circuit and a non-volatile memory and the resulting efficiency improvement in the panel driving; (2) the cost reduction by reducing the number of terminals of a memory control IC or the like provided in the control circuit; and (3) the cost reduction by reducing the capacity of the external non-volatile memory can be realized.

In particular, in (1) above, because of the speeding up of the clock frequency, the processing speed of the control circuit can be increased. Accordingly, for example, since the address operation speed in a sub-field can be increased and the amount of time saved by shortening the address operation period can be allocated to the sustain operation period, the luminance of PDP display can be increased.

### BRIEF DESCRIPTIONS OF THE DRAWINGS

FIG. 1 is a diagram showing the entire configuration of a PDP apparatus (flat panel display apparatus) according to an embodiment of the present invention;

FIG. 2 is a diagram showing the configuration of a field and a sub-field (drive sequence) based on the sub-field method in the PDP apparatus according to an embodiment of the present invention;

FIG. 3 is a diagram showing the entire block configuration of a control circuit unit in the PDP apparatus according to an embodiment of the present invention;

FIG. 4 is a diagram showing a block configuration of a characteristic portion of the control circuit unit in the PDP apparatus according to an embodiment of the present invention;

FIG. 5 is a diagram showing the operation timing immediately after the system start up of the control circuit unit in the PDP apparatus according to an embodiment of the present invention;

FIG. 6 is a diagram showing the operation timing in the normal operation of the control circuit unit in the PDP apparatus according to an embodiment of the present invention;

FIG. 7 is a diagram showing the portion a in the operation timing of the control circuit unit in an enlarged manner in the PDP apparatus according to an embodiment of the present invention;

FIG. 8 is a diagram showing the comparison between the waveform data stored in the SFM in the PDP apparatus according to an embodiment of the present invention and the waveform data stored in the conventional PFM;

FIG. 9 is a diagram showing an example of the conventional waveform (waveform A) to be the basis of the production of the waveform data in the PDP apparatus according to an embodiment of the present invention;

FIG. 10 is a diagram showing an example of the conventional waveform (waveform B) to be the basis of the production of the waveform data in the PDP apparatus according to an embodiment of the present invention;

FIG. 11A is a diagram showing an example of the waveform data corresponding to the waveform A stored in the conventional PFM;

FIG. 11B is a diagram showing an example of the waveform data corresponding to the waveform B stored in the conventional PFM;

FIG. 12 is a diagram showing an example of decoding data produced from the waveform data of the waveform A and the waveform B in the PDP apparatus according to an embodiment of the present invention;

FIG. 13A is a diagram showing an example of the decoding address data (set) of the waveform A;

FIG. 13B is a diagram showing an example of the decoding address data (set) of the waveform B;

FIG. 14 is a diagram showing an example of the configuration of an X sustain pulse generating circuit in the X drive circuit in the PDP apparatus according to an embodiment of the present invention;

FIG. 15 is a diagram showing an example of (a part of) the X sustain pulse and the switch control of the X sustain pulse generating circuit in the PDP apparatus according to an embodiment of the present invention; and

FIG. 16 is a diagram showing the configuration of a control circuit unit in a PDP apparatus of a conventional technology.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

<Premised Technology>

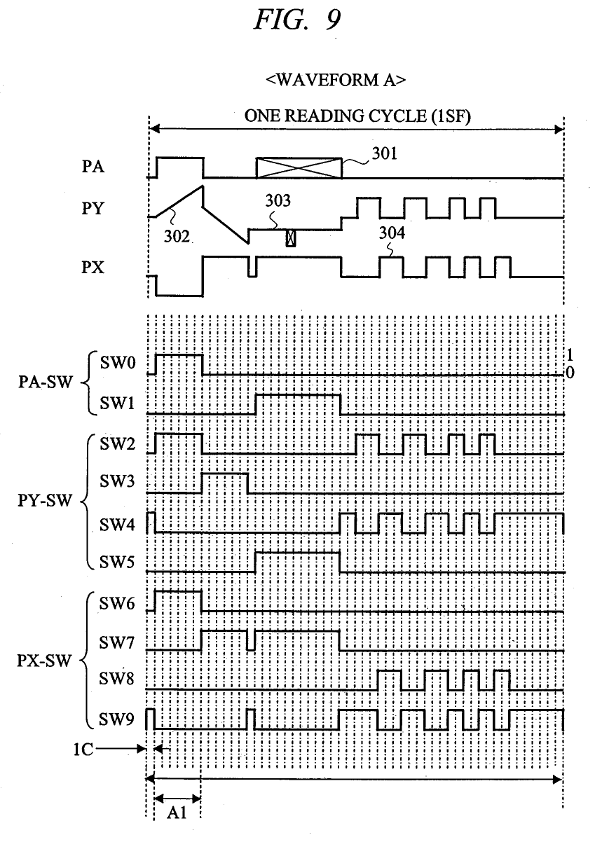

A conventional technology (premised technology) for the embodiment of the present invention will be briefly described with reference to FIG. 16 so as to make the embodiment of the present invention easily understood. Also, the contents shown in FIG. 9 to FIG. 11 also relate to the conventional technology.

In FIG. 16, in the configuration of a control circuit unit 900 of a conventional PDP apparatus, an LSI (waveform generating circuit LSI) 920 and a PFM 930 are connected by a parallel I/F (for example, parallel data bus is 16 bits). Waveform data (D) 950 (first waveform) is stored in the PFM 930 (corresponding to FIG. 8). A shift register (register array) 90 and a waveform generating circuit 93 are provided in the LSI 920. Since the operation of the shift register 90 is similar to that of the conventional technology described in the Patent Document 1 or the like, the description thereof is omitted here.

In an internal clock of the LSI 920, the waveform data (D) 950 in the PFM 930 to be used for each one SF is selected and read to a shift register (register array) 90 by each one cycle (one step), and a waveform (second waveform) generated in the waveform generating circuit 93 is outputted to each driver (high-voltage circuit). Each of the control switches in each driver is turned ON/OFF by the outputted waveform (second waveform), thereby outputting (applying) the drive waveforms to PDP electrodes.

As the timing control in the conventional technology, the waveform data (D) 950 is always read by accessing the PFM 930 in each SF of a field. The minimum access time of the PFM 930 is about 55 ns even in the high-speed memory. Therefore, in the conventional technology described above, the clock speed in the control of the LSI 920 and the parallel I/F is restricted, which prevents the speeding up of the reading of the waveform data (D) 950 and the output and generation of the waveform.

In the conventional PFM 930, for example, 40 control terminals (address input, data input/output, write enable, output enable, chip enable and others) are required. Similarly, 40 terminals are required in the memory control IC and others on the side of the LSI 920. Such large number of terminals cause the cost increase.

### Embodiment

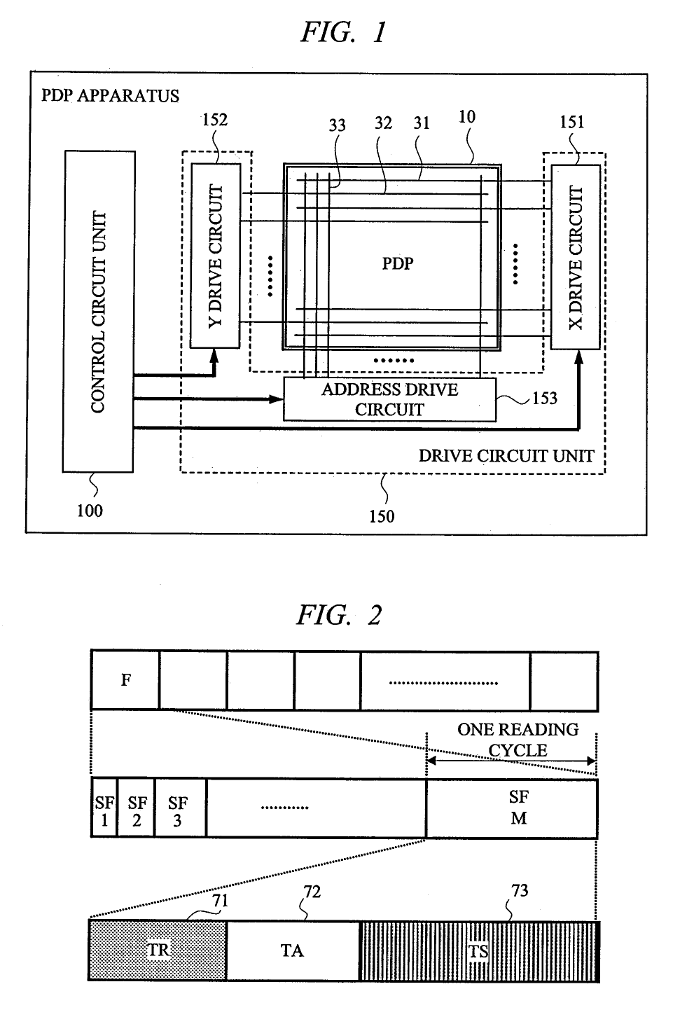

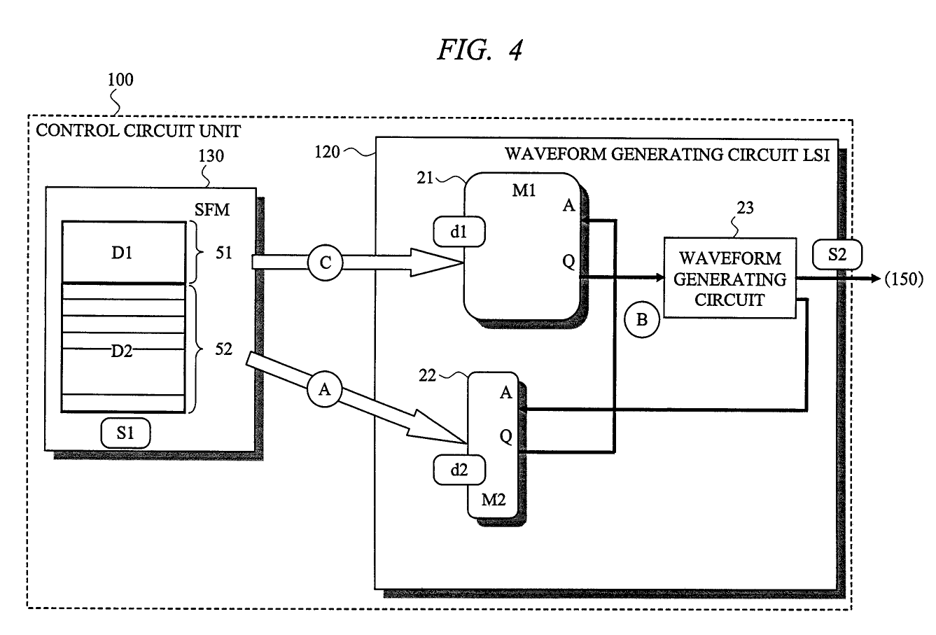

Based on the foregoing, a PDP apparatus according to an embodiment of the present invention will be described with reference to FIG. 1 to FIG. 15. In this embodiment, as shown in FIG. 4 and others, the waveform data (first waveform (S1)) is stored in an SFM 130 in the separated form of waveform decoding data (D1) 51 and a waveform decoding address set (D2) 52. An LSI 120 reads a necessary amount of waveform data from the SFM 130 and stores it in an internal SRAM unit 20 (M1, M2), and it also generates and outputs a second waveform (S2) from a waveform generating circuit 23.

PDP Apparatus

FIG. 1 shows the entire configuration of the PDP apparatus according to the present embodiment. The PDP apparatus is provided with a control circuit unit 100, a drive circuit unit (high-voltage circuit unit) 150, and a PDP 10. The drive circuit unit 150 (151 to 153) is controlled by the control circuit unit 100. The drive circuit unit (high-voltage circuit unit) 150 includes an X drive circuit 151, a Y drive circuit 152 and an address drive circuit 153. The X drive circuit 151 drives an X electrode (sustain electrode) 31 group of the PDP 10 (sustain drive). The Y drive circuit 152 drives a Y electrode (scan electrode) 32 group of the PDP 10 (scan drive and sustain drive). The address drive circuit 153 drives an address electrode 33 group of the PDP 10 (address drive). In the structure of the PDP 10, for example, display cells are disposed at intersecting points between the pairs of X electrodes 31 and Y electrodes 32 extending in a lateral direction and the address electrodes 33 extending in a longitudinal direction. A pixel is formed from a set of display cells with the colors of R (red), G (green) and B (blue). The display area (screen) is formed by the matrix of the display cells (pixels).

<Field and Sub-field>

As a basis of the drive control of the PDP 10 based on the sub-field (SF) method, the field and SF configuration (drive sequence) will be described with reference to FIG. 2. The field (F) is a unit related to the display area of the PDP 10, the vertical period of an image (vertical synchronizing signal: VS), and an image frame configuring the image. The vertical period is, for example, 1/60 second. The field (F) includes a plurality of (M) sub-fields (SF1 to SFM) obtained by dividing the field (F) in terms of time for the grayscale expression. M is, for example, 8 to 10. The sub-field SF (SF1 to SFM) is configured to have, for example, a reset period (Tr) 71, an address period (Ta) 72, and a sustain period (Ts) 73 in this order. A predetermined weight relative to the luminance (Ts 73) is given to each of the SFs of the field (F). For example, SFs are arranged in an ascending order of weight in a field (F). The grayscale of the pixels of the image frame is expressed by the steps of the selective combinations of ON/OFF in the SF (SF1 to SFM) of each display cell.

In Tr 71, the reset operation for adjusting the charge state of the cell group in SF is performed. In the following Ta 72, the address operation for selecting the ON/OFF of the cell group in SF is performed. In the following Ts 73, the sustain operation in which, by repeatedly applying sustain pulses to the pairs of the X electrodes 31 and the Y electrodes 32, the sustain discharges are generated in the cells selected in the previous Ta 72, thereby emitting light and displaying images is performed.

In the system of the present embodiment, one reading cycle to be a unit of control is, for example, one SF period.

<Control Circuit Unit (Entire)>

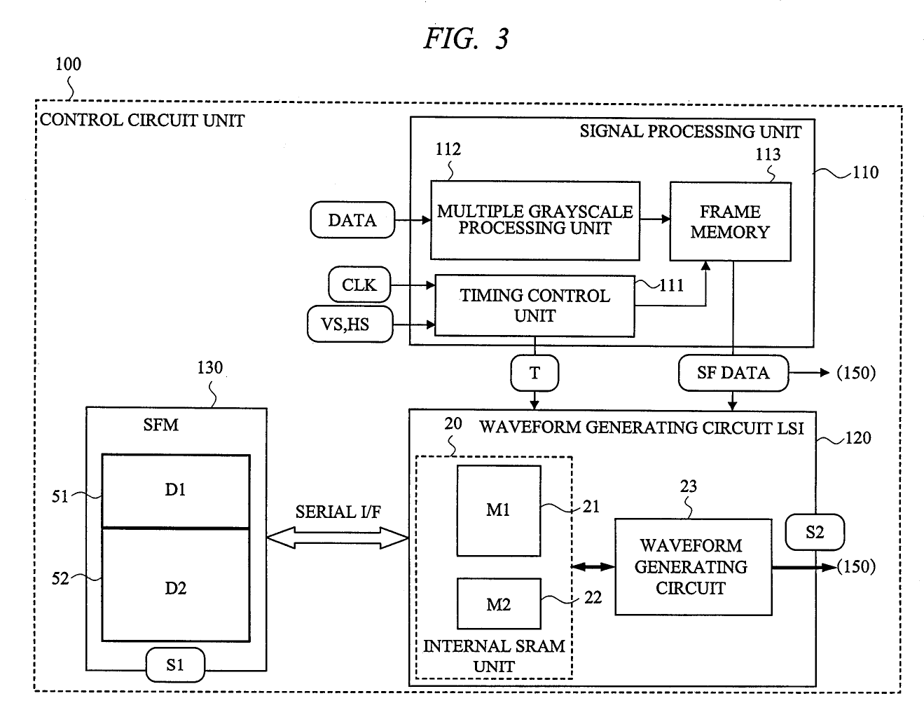

FIG. 3 shows the block configuration of the control circuit unit 100 of the PDP apparatus according to the present embodiment (basic configuration including the signal processing circuit).

The control circuit unit 100 is configured to have a signal processing unit (signal processing circuit) 110, an LSI (waveform generating circuit LSI) 120 and an SFM (serial flash memory) 130. The characteristic portion thereof (waveform generating circuit unit) is mounted as the LSI (waveform generating circuit LSI) 120. This LSI 120 is connected to the serial flash memory (SFM) 130 by a serial I/F. The SFM 130 is an external non-volatile memory for the waveform generating circuit LSI 120. A publicly known signal processing unit 110 is connected to the LSI 120.

The signal processing unit 110 includes a timing control unit 111, a multiple grayscale processing unit 112 and a frame memory 113. The multiple grayscale processing unit 112 performs an A/D conversion, a halftone generating process and an SF conversion process based on the inputted image data (DATA) to generate the display data (SF data) and output it to the LSI 120 and others. The SF data shows the ON/OFF of each cell in each SF of a field. The timing control unit 111 generates a timing control signal (defined as T) of the PDP driving based on the inputted clock (CLK), the vertical synchronizing signal (VS) and the horizontal synchronizing signal (HS) and outputs it to the LSI 120, the drive circuit unit 150 and other units. Note that it is also possible to integrally form the signal processing unit 110 and the waveform generating circuit LSI 120.

The drive waveform and the waveform data related to the generation thereof (first waveform: S1) are stored in the form of the waveform decoding data (D1) 51 and the waveform decoding address set (D2) 52 in the SFM 130 in advance. The LSI 120 is provided with a waveform generating circuit 23 and a first SRAM (M1) 21 and a second SRAM (M2) 22 as an internal SRAM unit 20. The control circuit unit 100 generates a drive control signal (second waveform: S2) based on the first waveform (S1) and outputs it to the drive circuit unit 150. The drive circuit unit 150 generates a drive waveform in accordance with the second waveform (S2) and outputs (applies) it to the electrodes (31, 32, 33) of the PDP 10. The second waveform is, for example, a signal for controlling the ON/OFF of a switch element such as FET (for example, LC resonant control switch and voltage clamp control switch) provided in the drive circuit.

The SFM 130 has, for example, six control terminals (signal data input, signal data output, serial clock, hold signal and others). Since the number of terminals is smaller than that of the conventional PEM 930, the cost reduction can be achieved.

<Control Circuit Unit (Characteristic Portion)>

FIG. 4 shows a block configuration of a characteristic system of the present embodiment, that is, a part of the control circuit unit (control circuit) 100.

The waveform decoding data (D1) 51 and the waveform decoding address set (D2) 52 (N sets) are stored in the SFM 130. These data (D1, D2) are prepared in the development and manufacture stage and recorded in the SFM 130 in advance. As the waveform decoding address set (D2) 52, N sets of decoding address used for the drive control, with the decoding address corresponding to one reading cycle being defined as one set (decoding address set), are stored in advance.

The LSI 120 is configured to include the waveform generating circuit 23 as a main component and further internal volatile memories such as a first SRAM (M1) 21 and a second SRAM (M2) 22. The first SRAM (M1) 21 is used to store the waveform decoding data (D1). The second SRAM (M2) 22 is used to store the waveform decoding address set (D2). Each SRAM (M1, M2) is connected to the SFM 130 via the serial I/F (serial data bus or the like).

As shown by the operation C, the first SRAM (M1) 21 stores the waveform decoding data (first data: d1) read and transferred from the waveform decoding data (D1) 51 in the SFM 130. As shown by the operation A, the second SRAM (M2) 22 stores the address data (second data: d2) selectively read and transferred from the waveform decoding address set (D2) 52 in the SFM 130. The waveform generating circuit 23 is connected to each high-voltage circuit (X drive circuit 151, Y drive circuit 152, address drive circuit 153). The waveform generating circuit 23 performs the reading control of each SRAM (M1, M2) as shown by the operation B.

<System Operation>

In FIG. 4, the main operation in this system is as follows. In this case, one reading cycle is defined as one SF. In this system, each of the data (D1, D2) in the SFM 130 is transferred and stored in each SRAM (M1, M2) in the LSI 120 by the operations A and C, and the drive control signal (second waveform) is generated through the waveform generating circuit 23 by the operation B and the signal is outputted to the drive circuit unit 150. In the operation C, the LSI 120 reads and transfers the waveform decoding data (D1) 51 in the SFM 130 and stores it in the first SRAM (M1) 21 (stored as the first data (d1) in M1). In the operation A, the LSI 120 selects a predetermined unit (set) of the waveform decoding address set (D2) 52 in the SFM 130 and reads and transfers it, and then stores it in the second SRAM (M2) 22 (stored as the second data (d2) in M2). Further, in the operation B, the waveform generating circuit 23 reads the data (d1, d2) in each SRAM (M1, M2), generates the second waveform, and then outputs it to the drive circuit unit 150.

The LSI 120 collectively takes the waveform decoding data (D1) 51 of the SFM 130 into first SRAM (M1) 21 at the system start up and before the driving, and thereafter, the refresh operation (SRAM compliant) for the first SRAM (M1) 21 is performed. Further, with regard to the waveform decoding address set (D2) 52, the LSI 120 selects the data (set) corresponding to the predetermined one reading cycle (one SF) at the timing of the head of each SF of a field and takes it into the second SRAM (M2) 22.

<Timing>

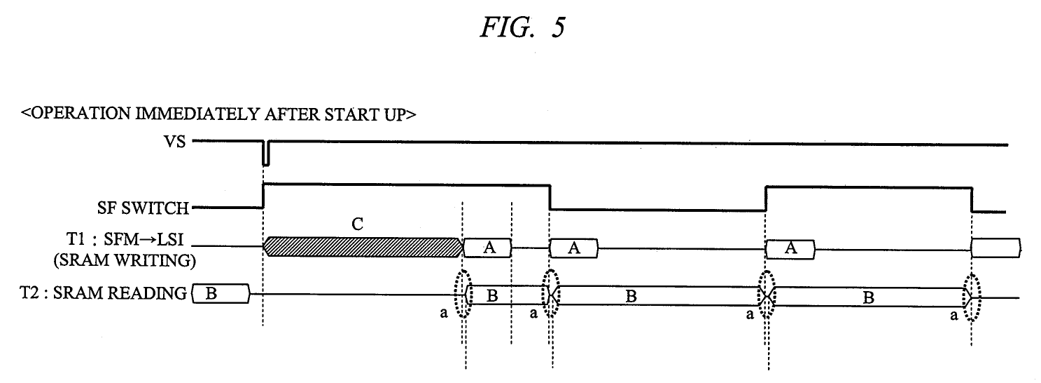

The main operation timing in this system will be described with reference to FIG. 5 to FIG. 7.

FIG. 5 shows a (schematic) timing chart of the operation immediately after the start up of this system (LSI 120). The data in FIG. 5 (A to C) correspond to each operation (A to C) in FIG. 4. From above, the signals of VS (vertical synchronizing signal), SF switching, T1: SFM-LSI (SRAM writing), and T2: SRAM reading are provided. VS shows the timing of a field. The SF switching shows the timing of each SF in a field. T1 shows the timing of the writing of data (D1, D2) from the SFM 130 to the LSI 120 (internal SRAM unit 20). T2 shows the timing of the reading of data (d1, d2) from the internal SRAM unit 20 (M1, M2) in the LSI 120. The LSI 120 plays the primary role in each operation.

In T1, immediately after the system start up, the waveform decoding data (D1) 51 is collectively read from the SFM 130 to the first SRAM (M1) 21 and it is stored therein as d1 by the operation C. Subsequently, by the operation A, the waveform decoding address set (D2) 52 corresponding to one reading cycle (one SF) is read from the SFM 130 to the second SRAM (M2) 22 and it is stored therein as d2. On the other hand, in T2, by the operation B along with the operation A, the waveform generating circuit 23 reads and inputs the waveform decoding data (d1) of the first SRAM (M1) 21, and generates and outputs the second waveform by using the waveform decoding address set (d2) of the second SRAM (M2) 22. More specifically, an address is inputted from the waveform generating circuit 23 to an A terminal of the second SRAM (M2) 22, and an address data output from a Q terminal of the second SRAM (M2) 22 is inputted to an A terminal of the first SRAM (M1) 21. Then, corresponding decoding data is read from a Q terminal of the first SRAM (M1) 21 and inputted to the waveform generating circuit 23, and the second waveform is generated and outputted by the inputted decoding data.

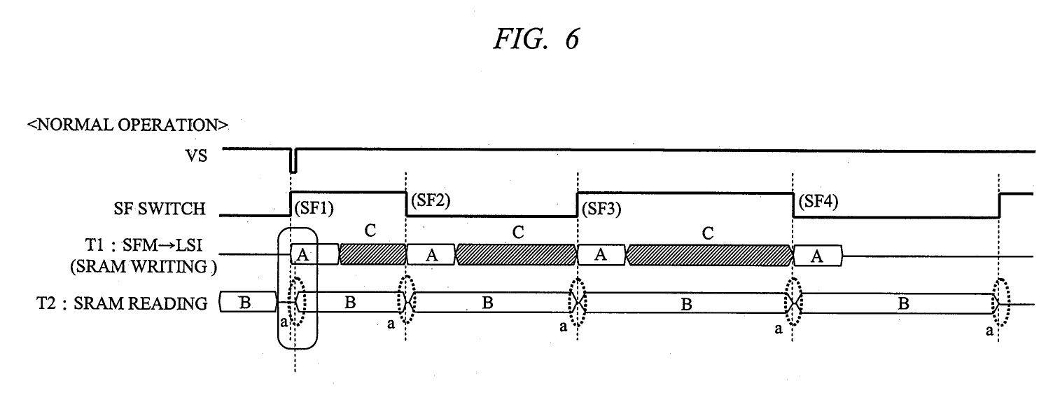

FIG. 6 shows the normal operation state in this system (LSI 120) in the same manner. In T1, at the beginning of each SF of a field, the LSI 120 reads the waveform decoding address set (D2) 52 corresponding to one reading cycle (one SF) from the SFM 130 to the second SRAM (M2) 22 to store it as d2 by the operation A. Subsequently, by the operation C, the refresh operation of the SFM 130 is performed. If the transfer is completed by the operation C, no transfer is performed. Further, in T2, the LSI 120 performs the operation B along with the operation A in each SF in the same manner as described above.

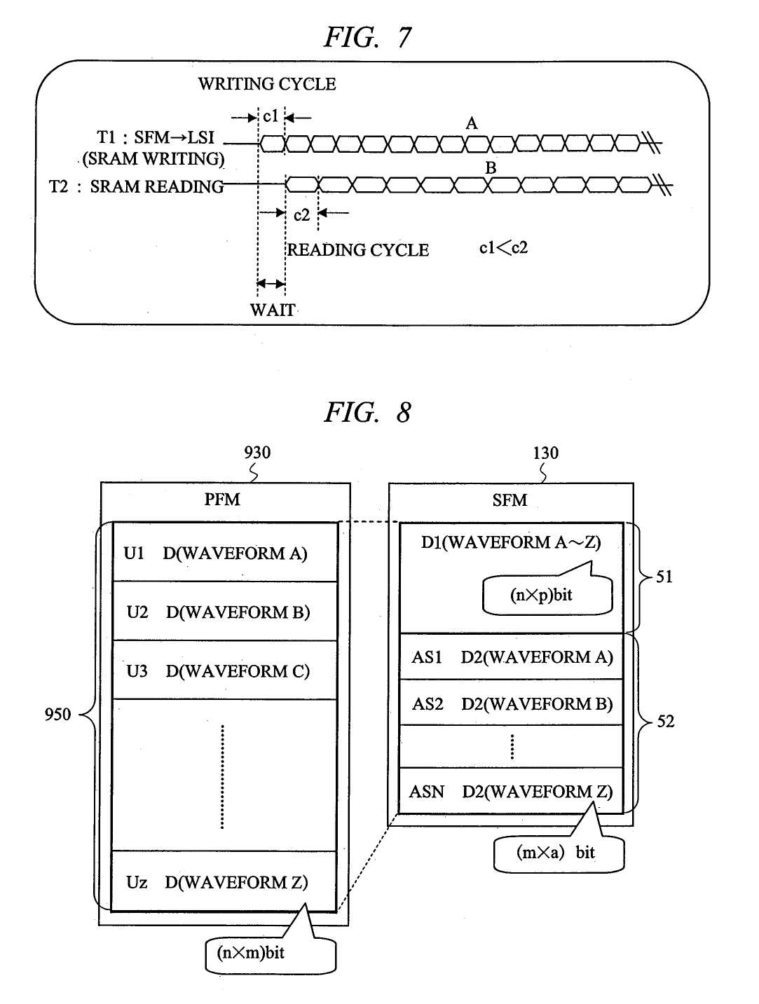

FIG. 7 shows a portion including the point indicated by a between the operations B (data B) in FIG. 5 and FIG. 6 in an enlarged manner. In this portion, the control is executed so that the SRAM reading of the operation B in T2 is started after the completion of the one cycle (cl) of SRAM writing (for example, data writing cycle corresponding to one address of SRAM 1) of the operation A in T1. c2 is one cycle of SRAM reading (for example, data reading cycle corresponding to one address of SRAM 1). Note that, in a WAIT period therebetween, the last waveform data in the previous SF in the waveform generating circuit 23 is outputted. Further, in T1 and T2, the writing cycle (c1) is configured to be shorter than the reading cycle (c2) (c1<c2). By this means, the reading operation in T2 does not overtake the writing operation in T1.

<Waveform Data>

FIG. 8 shows the comparison between the waveform data (D1, D2) stored in the SFM 130 of the present embodiment and the waveform data (D) stored in the conventional PFM 930. In the conventional PFM 930, the waveform and the waveform data (D) 950 related to the generation thereof separated for each waveform data corresponding to one reading cycle (for example, one SF) are sequentially stored. For descriptive purposes, the data corresponding to one reading cycle (one SF) is represented as U (U1 to Uz). For example, the data are stored in such a manner that U1 is data of waveform A, U2 is data of waveform B. The size of the data (U) corresponding to one reading cycle is “n×m” bits if the number of bits of the waveform (control switch) necessary for all drive control is set to n and the number of clock cycles (number of steps) in one reading cycle (one SF) is set to m. The total size of the waveform data (D) 950 stored in the PFM 930 is “n×m×z” bits if the number of data (U) corresponding to one reading cycle is set to z.

On the other hand, in the SFM 130 of the present invention, as the drive waveform and the waveform data related to the generation thereof (first waveform), the waveform decoding data (D1) 51 and the waveform decoding address set (D2) 52 (N sets) are stored in the separated form. In this data format, data can be compressed and the total capacity thereof can be reduced in comparison to the format of the conventional waveform data (D) 950. The waveform decoding data (D1) 51 is stored on the upper side, and each one set of the waveform decoding address (AS) is sequentially stored therebelow as the decoding address set (D2) 52 in an order of AS1: waveform A decoding address data, AS2: waveform B decoding address data, . . . .

The waveform decoding data (D1) 51 is obtained by analyzing and extracting the patterns of the waveform groups (waveform combination) per a predetermined unit (each clock cycle) from the waveforms necessary for all drive control. The size of the waveform decoding data (D1) 51 is “n×p” bits if the number of bits of the waveform (control switch) necessary for all drive control is set to n and the number of units (in order word, patterns) of the waveform group per one clock cycle in n (number of waveform units) is set to p. p is not “m×z” but is a value close to m. The reason thereof is that the total amount of waveform data is compressed as the number of the same patterns in all SF waveforms is larger and there is a high possibility that the same patterns actually exist in main steps such as Tr 71, Ta 72 and Ts 73 of SF.

The waveform decoding address set (D2) 52 (N sets) is address data for referencing and reading the waveform decoding data (D1). Incidentally, AS indicates a set of the decoding address for referencing the waveform of the predetermined one reading cycle (waveform decoding address set). For example, AS1 is a decoding address set of the waveform A. As the waveform decoding address set (D2) 52, a number of (N) sets corresponding to the necessary waveforms (for example, waveform A to waveform Z) are stored. The size of the waveform decoding address set (D2) 52 is “m×a” bits in one set (AS) and “m×a×N” bits in the whole (N sets) if the number of clock cycles (number of steps) in one set (one reading cycle) is set to m and the number of bits of an address is set to a. a is the number of bits after the binary conversion of p.

The total size of the data (D1, D2) stored in the SFM 130 is “n×p”+“m×a×N” bits. This is smaller than the size of the waveform data (D) 950 (“n×m×z” bits) stored in the PFM 930. Considering the reason described above (reason why p is a value close to m), the method of the present invention is more effective. For example, the values described above are as follows. When the number of control bits n is large, for example, when n=32, m=1024, p=m, a=10, and N=z=32, the size of the data stored in the SFM 130 is 135168 bits and the size of the data stored in the PFM 930 is 327680 bits, and the data compression effect can be clearly exerted.

<Waveform Data (D) of PFM>

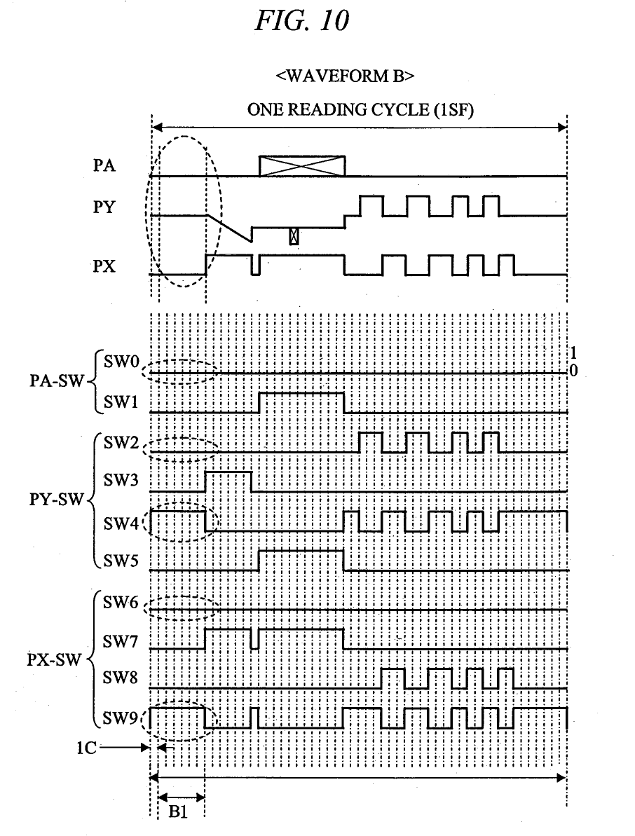

The configuration of the waveform data (D, D1, D2) in FIG. 8 will be further described with reference to FIG. 9 to FIG. 13. First, the waveform data (D) 950 stored in the PFM 930 in the conventional PDP apparatus, which is the basis of the production of the waveform data (D1, D2) of the present embodiment, will be described with reference to FIG. 9 and FIG. 10. As the waveform data (D) 950, the drive waveform and the waveform data (first waveform) related to the generation thereof are stored for each cycle configured of a plurality of clock cycles in the external PFM 930 for the LSI of the conventional control circuit.

FIG. 9 shows the waveform A which is an example of the conventional necessary waveform. The waveform A has the unit of one reading cycle (in the case of one SF). From above, drive waveforms of PA (drive waveform of address electrode 33), PX (drive waveform of X electrode 31) and PY (drive waveform of Y electrode 32), and waveforms for controlling control switches SW (SW control signals) for generating these drive waveforms such as PA generating SW (PA-SW), PY generating SW (PY-SW) and PX generating SW (PX-SW) are shown. The one clock cycle (1C) of the waveform is indicated by an interval between vertical lines. Note that drive waveforms such as the PA and others correspond to the second waveforms outputted from the drive circuit unit 150. The waveforms for controlling the switches (SW control signal) are the waveforms for controlling the ON (1)/OFF (2) of the switches (SW) and they correspond to the first waveforms outputted from the control circuit unit 100. A total of 10 control switches SW such as SW0 to SW9 are provided (n=10).

In the shape of the waveform, for example, in PA, a plurality of address pulses 301 applied in the address period (Ta) 72 are provided. Further, in PX and PY, a reset pulse 302 applied in the reset period (Tr) 71, a scan pulse 303 applied in the address period (Ta) 72, a sustain pulse 304 applied in the sustain period (Ts) 73 and others are provided.

Similarly, FIG. 10 shows the conventional waveform B. The portion B1 of this waveform B is different from the corresponding portion (A1) of the waveform A.

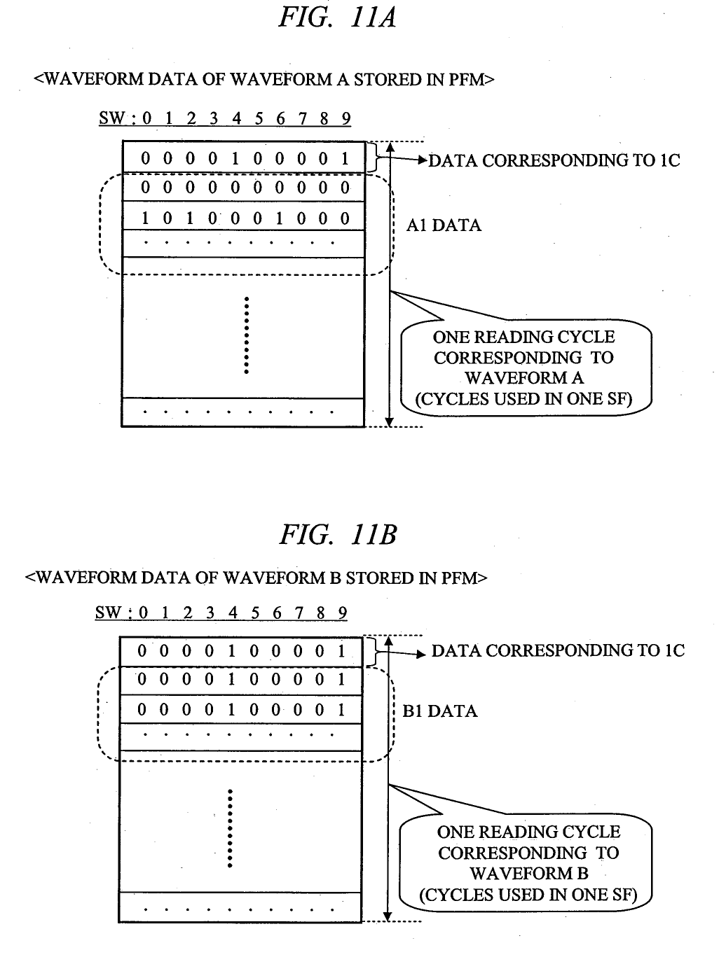

Next, FIG. 11A shows an example of the waveform data (D) stored in the PFM 930 corresponding to the waveform A in FIG. 9. The data of one reading cycle (one SF) corresponding to the waveform A is sequentially stored for each one clock cycle (C) (each one row). In this example, the bit of each column corresponds to the control switch SW (SW0 to SW9) of the drive circuit unit 150, and each row represents the data corresponding to one clock cycle (1C) of the waveform A. The data of one reading cycle (corresponding to the cycle (step) used in one SF) is stored by a plurality of successive rows. The A1 data in the several rows from the second row is the data corresponding to the A1 portion in FIG. 9.

Similarly, FIG. 11B shows an example of the waveform data (D) stored in the PFM 930 corresponding to the waveform B in FIG. 10. The data shown in FIG. 11A and FIG. 11B are stored in the same storing method. In this example, the B1 data in the several rows from the second row is the data corresponding to the B1 portion in FIG. 10. Except the B1 data, it is the same as the stored data of the waveform A in FIG. 9.

As shown in FIG. 9 to FIG. 11 above, in the conventional system, even the waveforms (waveforms A and B) and the waveform data (D) which differ only partially in the waveform data corresponding to one reading cycle (one SF) are considered as the data of different waveforms (sets) and are stored in different address regions of the PFM 930. Therefore, the amount of stored data and the necessary capacity of the PFM 930 are large.

<Waveform Data (D1, D2) of SFM>

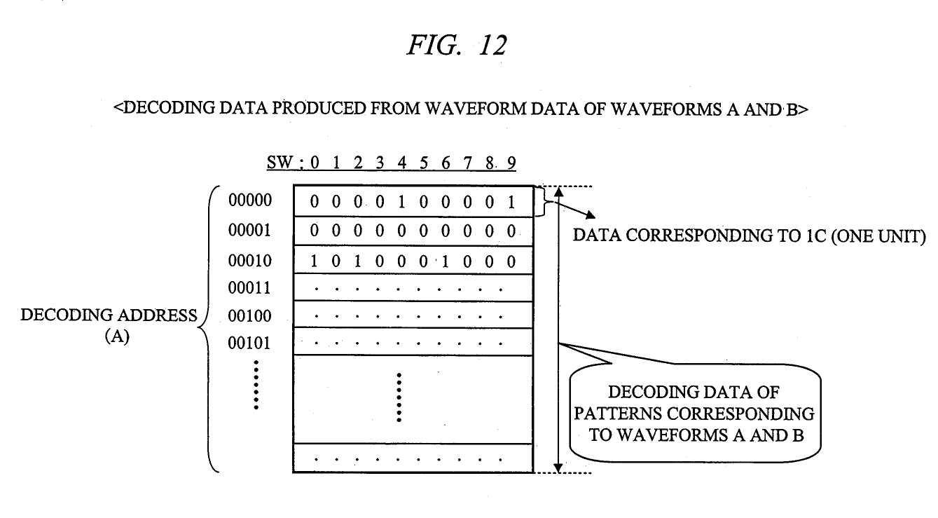

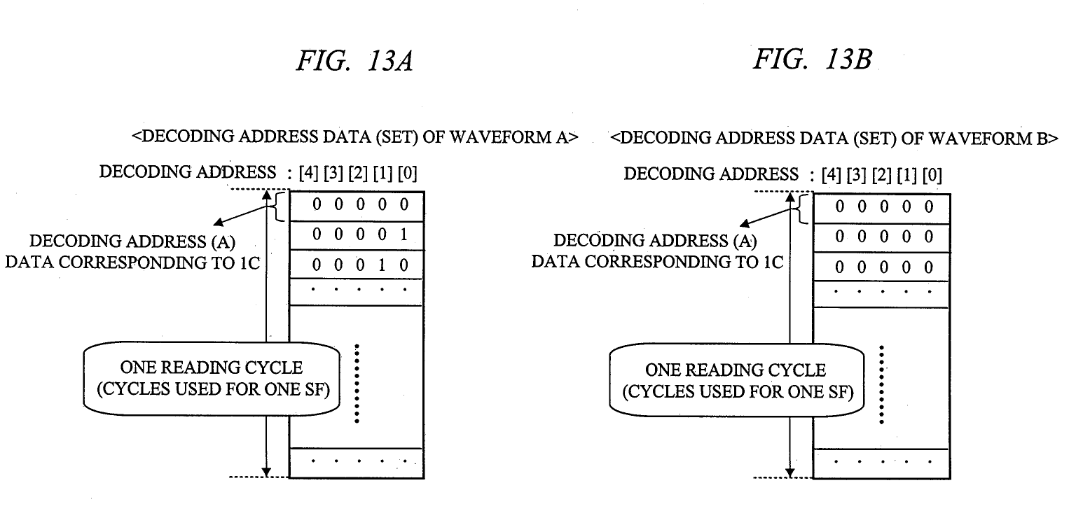

Next, in contrast to the configuration of the waveform data (D) 950 and others, the waveform data (D1, D2) stored in the SFM 130 in the system of the present embodiment will be described with reference to FIG. 12 and FIG. 13. The SFM 130 stores the waveform data (D1, D2) prepared based on the waveform data (D) 950.

In the development and manufacture stage of the PDP apparatus of the present invention, with regard to the conventional waveform data (D) 950 (for example, waveform data of the waveforms A and B described above), with one clock cycle (1C) being defined as one unit, the decoding data (corresponding to D1) which covers all waveform data units used for the drive control is produced. Then, a decoding address (corresponding to D2) for reading one unit (corresponding to 1C), a pattern (predetermined waveform), and a waveform corresponding to one reading cycle (one SF) from this decoding data (D1) is produced in the form of being defined for each one unit of the waveform. The conventional waveform data (D) 950 defined for each SF is replaced with the waveform decoding address set (D2) 52.

In FIG. 12, in the present embodiment, for example, the decoding data (corresponding to a part of D1) corresponding to the waveforms A and B is produced from the conventional waveform data of the waveform A shown in FIG. 9 and the conventional waveform data of the waveform B shown in FIG. 10. The one row is the data of 1C (one unit). This decoding data includes both the data of the above-described A1 and B1 portions so as to be configurable. The decoding address (denoted by A) is given so as to correspond to each row (one unit) in FIG. 12. The number of bits (a) of the decoding address (A) corresponds to the number of units of the waveform (number of rows), for example, 5 bits.

Further, as shown in FIG. 13A and FIG. 13B, the waveform A decoding address data (set) and the waveform B decoding address data (set) are produced based on the decoding data (corresponding to waveforms A and B) in FIG. 12. One row represents the data of the decoding address (A) corresponding to the 1C of the waveform. A plurality of rows represent the data corresponding to one reading cycle (corresponding to the cycles used in one SF), that is, the data of one set. In the configuration of the waveform decoding address data set (D2), for each cycle (step) configuring the target waveform (SF), the data of one unit is designated from the data group in FIG. 12 by an address and then arranged.

For example, the data of signals of SW0 to SW9 in 1C (one unit) is “0, 0, 0, 0, 1, 0, 0, 0, 0, 1” in the first row (address “00000”). The waveform decoding data (D1) 51 does not include the data having the same content (the same data is unified as one unit). By using one or more units as described above (number of waveform units: p) by the decoding address (arranging them on a time axis), a predetermined waveform (pattern) and the waveform of one reading cycle are formed. The waveforms necessary for all drive controls (for example, waveform A to waveform Z) are configured in the same manner, thereby configuring the stored data of the PFM 130 shown in FIG. 8.

<Second Waveform (Drive Control Signal)>

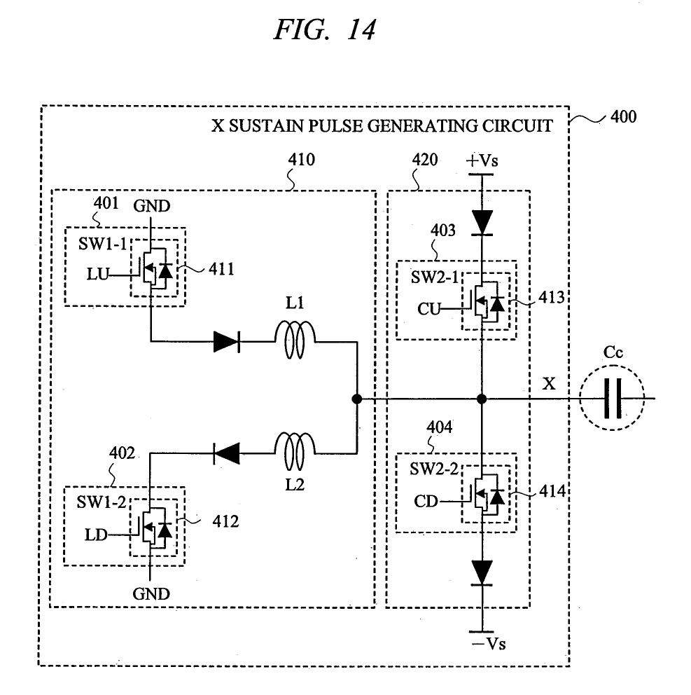

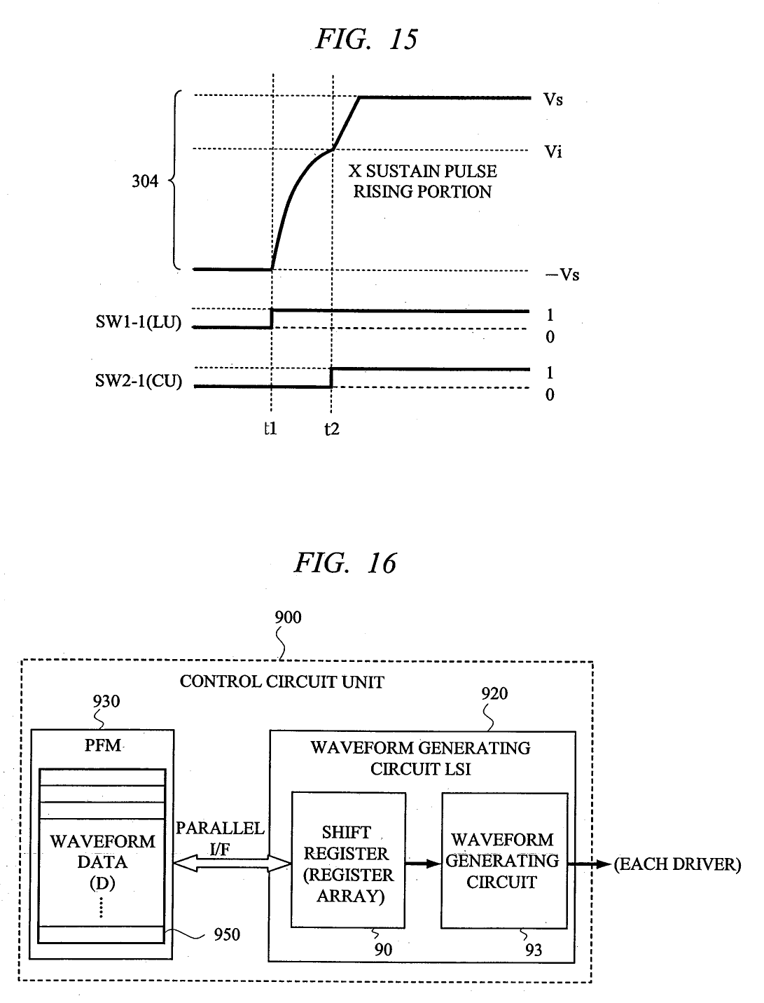

The second waveform (drive control signal) and others will be further described with reference to FIG. 14 to FIG. 15. As an example of the drive waveform and the switch control for generating the drive waveform in FIG. 9, the case of the sustain pulse 304 of PX and the X drive circuit 151 will be described. FIG. 14 shows an example of the configuration of the X sustain pulse generating circuit in the X drive circuit 151. FIG. 15 shows an example (of a part) of the switch control corresponding to FIG. 14.

In FIG. 14, an X sustain pulse generating circuit 400 is connected to an X electrode 31 of a display cell (capacitor Cc) of the PDP 10, and generates and applies an X sustain pulse to the X electrode 31. The X sustain pulse generating circuit 400 includes a Vs (sustain voltage) clamp circuit 420, and a power recovery circuit 410 is connected thereto. The power recovery circuit 410 has coils (L1, L2) connected to the capacitor Cc and switches (401, 402) for LC resonant control. The Vs clamp circuit 420 has switches (403, 404) for Vs clamp control and is connected to Vs power sources (+Vs, −Vs).

The switches for LC resonant control (401, 402) are a first switch (SW1-1) 401 for the LC resonance up (LU) control and a second switch (SW1-2) 402 for the LC resonance down (LD) control. The switches for Vs clamp control (403, 404) are a first switch (SW2-1) 403 for Vs clamp up (CU) control and a second switch (SW2-2) 404 for Vs clamp down (CD) control. Each of the switches (401 to 404) is configured to include a switch element such as FET (411 to 414). LU, LD, CU and CD in FIG. 14 also represent control inputs to each of the switch elements (411 to 414).

In FIG. 15, switch control signals for controlling an X sustain pulse, for example, a control input (LU) to the switch (SW1-1) 401 for the LC resonance up control and a control input (CU) to the switch element (SW2-1) 403 for the Vs clamp up control are inputted from the LSI 920 to the X drive circuit 151. In this manner, in the X sustain pulse generating circuit 400, ON/OFF of the corresponding switches (401, 402) is controlled, and the sustain pulse 304 (rising portion) is outputted. t1 and t2 represent timings. From the OFF (0) state of LU and CU, LU is turned ON (1) at the timing t1. Then, by the LC resonant operation (coil L1 and capacitor Cc), the waveform rises in a curve in which the voltage gently varies. Next, CU is turned ON (1) at the timing t2. Then, by the Vs clamp operation, the waveform rapidly rises from the state of voltage Vi to the state of voltage Vs.

As described above, according to the present embodiment, in the control circuit unit 100, because of the adoption of the SFM 130 with the serial I/F, the configuration of the waveform decoding data (D1) 51 and the waveform decoding address set (D2) 52 (ingenuity for data compression), and the configuration of the internal SRAM unit (M1, M2), (1) the speeding up of the clock frequency in the SFM 130 and the control circuit unit 100 (waveform generating circuit LSI 120), (2) the reduction in the number of terminals of a memory control IC or the like in the waveform generating circuit LSI 120 owing to the serial I/F, and (3) the reduction in the capacity of the SFM 130 and the stored data (D1, D2) can be achieved.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be used for a flat panel display apparatus such as a PDP apparatus.

What is claimed is:

1. A drive control circuit device for a flat panel display apparatus provided in a flat panel display apparatus and configured to have a waveform generating circuit unit generating a waveform for driving a panel,
in an external non-volatile memory, a drive waveform and waveform data related to generation of the drive waveform being stored as a first waveform for each cycle configured of a plurality of clock cycles, and a second waveform for driving the panel being generated by using the first waveform stored in the non-volatile memory,
the drive control circuit device comprising:
an internal first volatile memory, in which drive waveform decoding data which covers all waveform data units used for panel drive control is stored as first data; and
an internal second volatile memory, in which only an amount of data of a decoding address for reading desired data from the drive waveform decoding data, said amount corresponding to a predetermined reading cycle, is stored as second data.

2. The drive control circuit device for a flat panel display apparatus according to claim 1,
wherein the non-volatile memory is a serial flash memory connected to the first and second volatile memories by a serial interface.

3. The drive control circuit device for a flat panel display apparatus according to claim 1,
wherein, as the drive waveform decoding data, with one clock cycle of the first waveform being defined as one unit, data which covers all waveform data units used for the panel drive control is stored in the non-volatile memory in advance.

4. The drive control circuit device for a flat panel display apparatus according to claim 1,
wherein, as the data of a decoding address, with one reading cycle being defined as one set, data corresponding to the number of sets used for the panel drive control is stored in the non-volatile memory in advance.

5. The drive control circuit device for a flat panel display apparatus according to claim 3,
wherein the drive waveform decoding data stored in the non-volatile memory is all stored in the first volatile memory as the first data immediately after start up of a system, and thereafter, a refreshing operation is performed to the first data in the first volatile memory as needed.

6. The drive control circuit device for a flat panel display apparatus according to claim 1,
wherein, as the drive waveform decoding data, with one clock cycle of the first waveform being defined as one unit, data which covers all waveform data units used for the panel drive control is stored in the non-volatile memory in advance,
as the data of a decoding address, with one reading cycle being defined as one set, data corresponding to the number of sets used for the panel drive control is stored in the non-volatile memory in advance,
the drive waveform decoding data stored in the non-volatile memory is all stored in the first volatile memory as the first data immediately after start up of a system, and thereafter, a refreshing operation is performed to the first data in the first volatile memory as needed, and
one set of the decoding address stored in the non-volatile memory is stored in the second volatile memory immediately after start up of a system and after storing the drive waveform decoding data.

7. The drive control circuit device for a flat panel display apparatus according to claim 4,
wherein one set of the decoding address stored in the non-volatile memory is stored in the second volatile memory at a switch of the reading cycle.

8. The drive control circuit device for a flat panel display apparatus according to claim 4,
wherein a set selected for each of the reading cycles from a plurality of sets of the decoding address stored in the non-volatile memory is stored in the second volatile memory.

9. The drive control circuit device for a flat panel display apparatus according to claim 6,
wherein, in the waveform generating circuit unit generating the second waveform based on each data stored in the first and second volatile memories, when one set of the decoding address is to be stored in the second volatile memory, immediately after storing the decoding address corresponding to one clock cycle, the stored decoding address is read, and the second waveform is produced with reference to the drive waveform decoding data stored in the first volatile memory by the decoding address.

10. The drive control circuit device for a flat panel display apparatus according to claim 7,
wherein, in the waveform generating circuit unit generating the second waveform based on each data stored in the first and second volatile memories, when one set of the decoding address is to be stored in the second volatile memory, immediately after storing the decoding address corresponding to one clock cycle, the stored decoding address is read, and the second waveform is produced with reference to the drive waveform decoding data stored in the first volatile memory by the decoding address.

11. The drive control circuit device for a flat panel display apparatus according to claim 8,
wherein, in the waveform generating circuit unit generating the second waveform based on each data stored in the first and second volatile memories, when one set of the decoding address is to be stored in the second volatile memory, immediately after storing the decoding address corresponding to one clock cycle, the stored decoding address is read, and the second waveform is produced with reference to the drive waveform decoding data stored in the first volatile memory by the decoding address.

12. The drive control circuit device for a flat panel display apparatus according to claim 6,
wherein a writing cycle of a circuit of the second volatile memory storing the decoding address is designed to be faster than a reading cycle of the decoding address of the circuit.

13. The drive control circuit device for a flat panel display apparatus according to claim 7,
wherein a writing cycle of a circuit of the second volatile memory storing the decoding address is designed to be faster than a reading cycle of the decoding address of the circuit.

14. The drive control circuit device for a flat panel display apparatus according to claim 8,
wherein a writing cycle of a circuit of the second volatile memory storing the decoding address is designed to be faster than a reading cycle of the decoding address of the circuit.
